(19) United States
(12) Patent Application Publication
(10) Pub. No.: US 2012/0154306 A1
(43) Pub. Date: Jun. 21, 2012

(54) METHOD AND APPARATUS FOR INPUTTING CHARACTER USING TOUCH INPUT

(75) Inventors: Jeong Hun Kim, Gumi-si (KR); Young Seoung Joo, Seoul (KR); Eun Sun Kim, Suwon-si (KR)

(73) Assignee: SAMSUNG ELECTRONICS CO., LTD., Suwon-si (KR)

(21) Appl. No.: 13/289,836

(22) Filed: Nov. 4, 2011

(30) Foreign Application Priority Data
Dec. 17, 2010 (KR) 10-2010-0129804

(51) Int. Cl. G06F 3/041

(52) U.S. Cl. 345/173

(57) ABSTRACT

An apparatus and a method for inputting a character are provided. The apparatus for inputting a character includes a touch input unit configured to sense a generation and a contact point of a touch. The apparatus also includes a memory configured to store mapping information regarding a displacement and a character according to movement of the generated touch. The apparatus further includes a controller configured to extract and output a character corresponding to a displacement of a sensed touch while the touch maintains upon sensing the touch. The apparatus also includes a display unit configured to display the output character. The method and apparatus for inputting a character may increase character input speed, and provide an environment similar to a keyboard of a PC, for example, a key arrangement of a QWERTY type to improve convenience for a user.

### CROSS-REFERENCE TO RELATED APPLICATION(S) AND CLAIM OF PRIORITY

The present application is related to and claims the benefit under 35 U.S.C. §119(a) of a Korean patent application filed in the Korean Intellectual Property Office on Dec. 17, 2010 and assigned Application No. 10-2010-0129804, the entire disclosure of which is hereby incorporated by reference.

### TECHNICAL FIELD OF THE INVENTION

The present invention relates to a method and an apparatus for inputting a character, and more particularly, to a method for efficiently inputting a character using touch input and an apparatus thereof.

### BACKGROUND OF THE INVENTION

In recent years, a portable terminal has become a modern necessity. With the development of technology, the portable terminal may provide various data transmission services and additional services as well as unique voice call services. For example, the portable terminal has provided a digital broadcasting service, a wireless Internet service, and a short message service (SMS).

The SMS is a service that transmits and receives simple texts to and from another user. To this end, the portable terminal may include a character input device such as a 3*4 key pad or a touch screen for inputting a character. However, it is more convenient for a character input device of a conventional portable terminal to input a character and character input speed is reduced as compared with a keyboard used as an input device of a personal computer (PC). Accordingly, there is a need for a method and an apparatus for inputting a character of a portable terminal capable of easily inputting a character and increasing character input speed. Further, recently, as SMS services such as Twitter® have been added to the portable terminal, use of electronic mail has increased, and character input used for office applications for a smart phone has widely increased, importance of character input has been increased.

### SUMMARY OF THE INVENTION

To address the above-discussed deficiencies of the prior art, it is a primary object to provide a method for inputting a character capable of improving convenience of character input and character input speed, and an apparatus thereof.

In accordance with an aspect of the present invention, an apparatus for inputting a character includes a touch input unit configured to sense a generation and a contact point of a touch. The apparatus also includes a memory configured to store mapping information regarding a displacement and a character according to movement of the generated touch. The apparatus further includes a controller configured to extract and output a character corresponding to a displacement of a sensed touch while the touch maintains upon sensing the touch. The apparatus also includes a display unit configured to display the output character.

In accordance with another aspect of the present invention, a method for inputting a character in an apparatus with a plurality of touch input units is provided. The method includes sensing a generation and a contact point of a touch by a touch input unit. The method also includes extracting and outputting a character corresponding a displacement of a sensed touch while the touch maintains upon sensing the touch. The method further includes displaying the output character.

A method and an apparatus for inputting a character according to an embodiment of the present invention may increase character input speed, and provide an environment similar to a keyboard of a PC, for example, a keyboard having a QWERTY key arrangement, to improve convenience for a user.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a block diagram illustrating a configuration of an apparatus for inputting a character according to an embodiment of the present invention;

FIG. 2 is a rear view illustrating an apparatus for inputting a character according to an embodiment of the present invention;

FIGS. 3A and 3B are views illustrating examples of an apparatus for inputting a character according to an embodiment of the present invention;

FIG. 4A is a flowchart illustrating a method for inputting a character according to a first embodiment of the present invention;

FIG. 4B is a flowchart illustrating a method for inputting a character according to a second embodiment of the present invention;

FIG. 5 is a view illustrating an example of a screen displayed on a display unit according to a second embodiment of the present invention;

FIG. 6 is a schematic diagram illustrating a touch input type according to a second embodiment of the present invention; and

FIG. 7 to FIG. 10B are views illustrating a character selection scheme according to a touch.

### DETAILED DESCRIPTION OF THE INVENTION

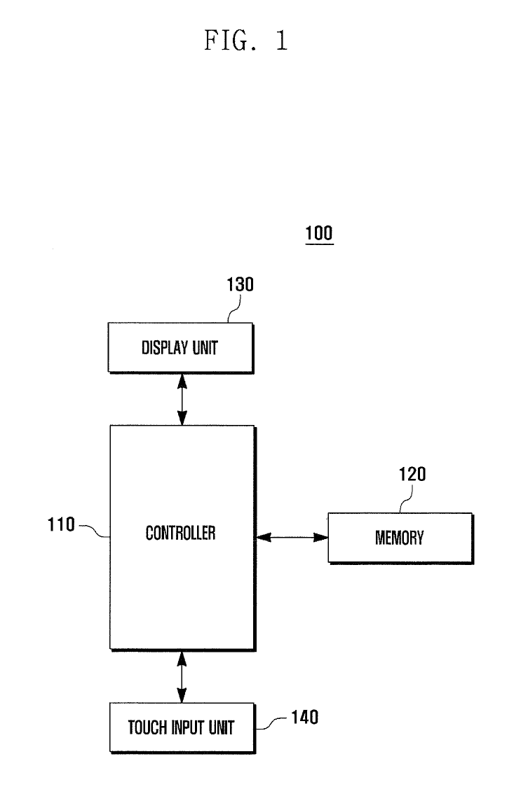

FIGS. 1 through 10B, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged portable terminal. The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Hereinafter, exemplary embodiments of the present invention are described with reference to the accompanying drawings in detail.

FIG. 1 is a block diagram illustrating a configuration of an apparatus 100 for inputting a character according to an embodiment of the present invention. The apparatus 100 may represent, or be part of, a device such as a portable terminal.

Referring to FIG. 1, the apparatus 100 for inputting a character according to an embodiment of the present invention includes a controller 110, a memory 120, a display unit 130, and a touch input unit 140.

The touch input unit 140 senses a user touch. For example, the touch input unit 140 may be implemented in the form of a touch pad. The touch input unit may sense a generation or termination of a touch. When a contact point of a touch moves in a maintained state of the touch (i.e., while the touch is maintained, without interruption or break), the touch input unit 140 may sense a moving direction and a moving distance of the contact point of the touch. Hereinafter, in the specification, a touch moving a contact point of the touch in a maintained state of the touch is referred to as ‘slide input’. Further, a moving distance and a moving direction of a contact point of the touch by slide input is referred to as ‘displacement of a touch’. As illustrated previously, the displacement of the touch includes a moving direction of the touch as well as a moving distance of the touch.

The touch input unit 140 may be configured by a capacitive overlay type, a pressure resistive overlay type, or an infrared beam type touch sensor or a pressure sensor. Besides the foregoing sensors, various types of a sensor capable of sensing contact or pressure of an object may be configured as the touch input unit 140 of the present invention. The touch input unit 140 senses a user touch to generate and transmit a sensing signal to the controller 110. The sensing signal contains coordinate data corresponding to a user touch. When a user performs a slide input, the touch input unit 140 may generate and transmit a sensing signal with data regarding a displacement of a touch to the controller 110.

The touch input unit 140 according to an embodiment of the present invention may be provided at an opposite surface of the display unit 130 of the apparatus 100. Further, the apparatus 100 may include a plurality of (e.g., six) touch input units 140. Detailed constructions of the touch input unit 140 and an operation thereof will be described below with reference to FIG. 5 to FIG. 10B.

The memory 120 store programs and data necessary for an operation of the apparatus 100, and may be divided into a program area and a data area. The program area may store a program controlling an overall operation of the apparatus 100, an operating system for booting the apparatus 100, an application program associated with playing multimedia contents, and application programs associated with other option functions of the apparatus 100, for example, a camera function, a sound playback function, images or moving images playback function. The data area stores data created according to use of the apparatus 100, for example, images, moving images, phone-books, and audio data.

The memory 120 according to an embodiment of the present invention maps corresponding characters to a displacement of a touch and stores the mapped result. When a contact point of a touch moves in a set direction by 2 mm while a touch maintains, it may be assumed that a character corresponding to the displacement of a touch is alphabet ‘e’. A mapped relationship of the characters to the displacement of a touch will be described with reference to FIG. 5 to FIG. 10B below.

The controller 110 controls overall operations of respective structural elements of the apparatus 100.

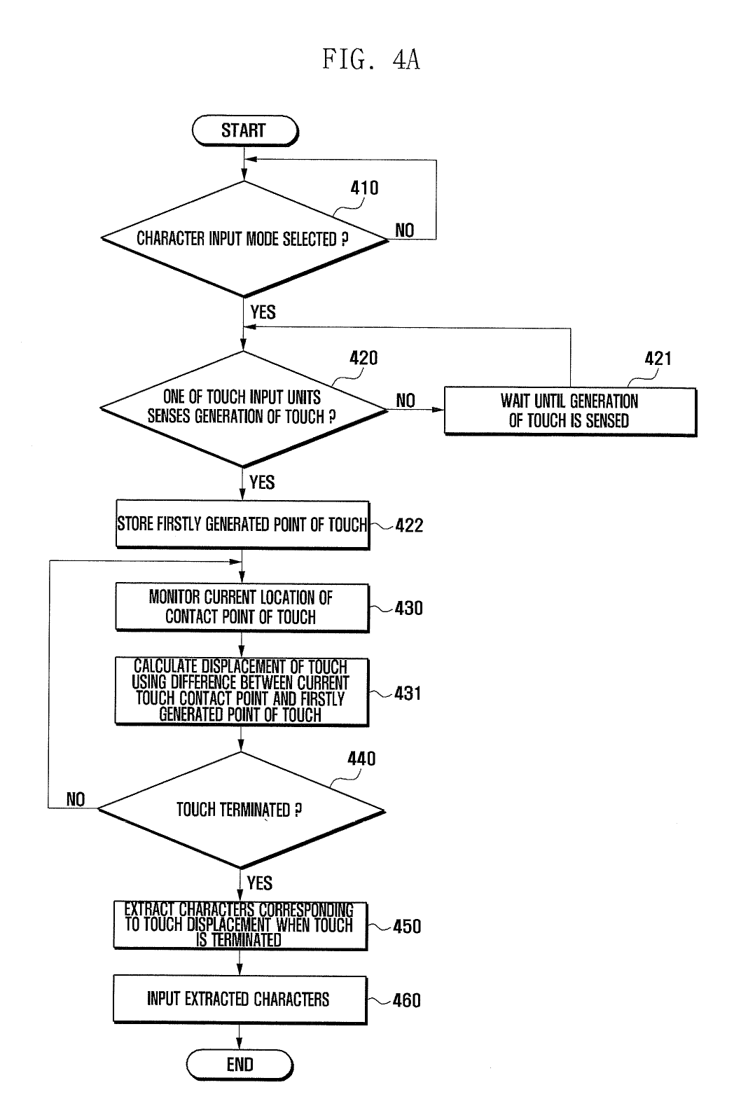

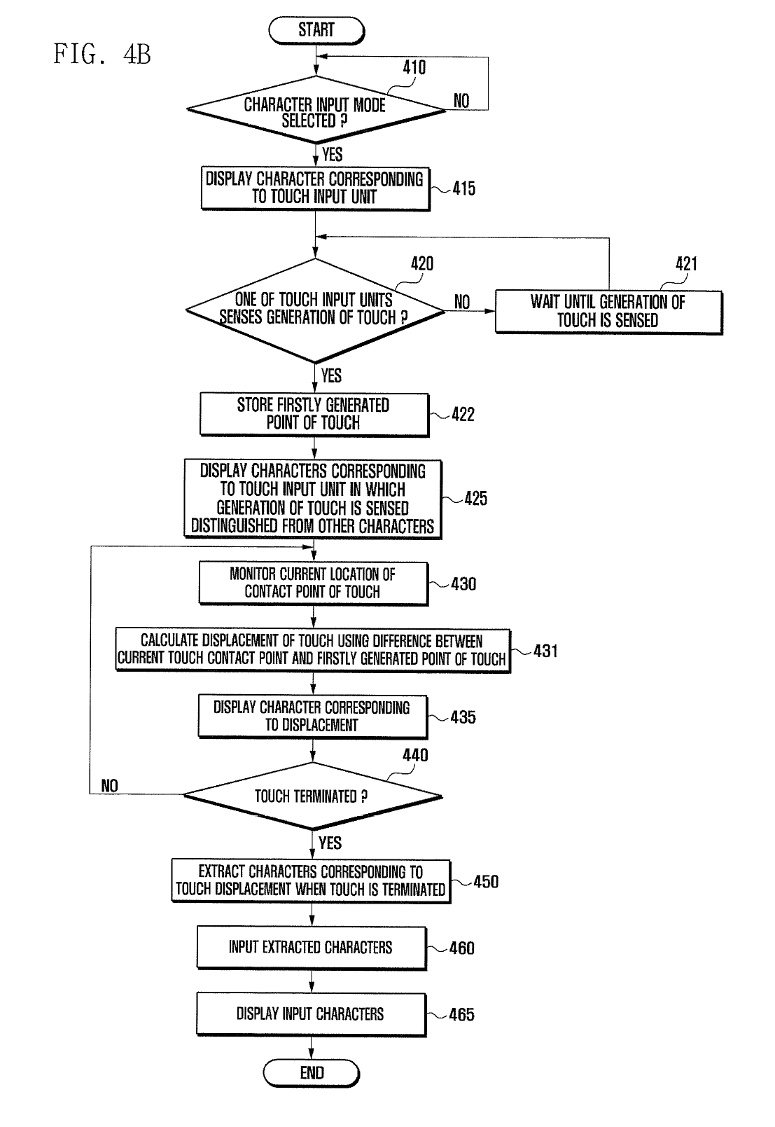

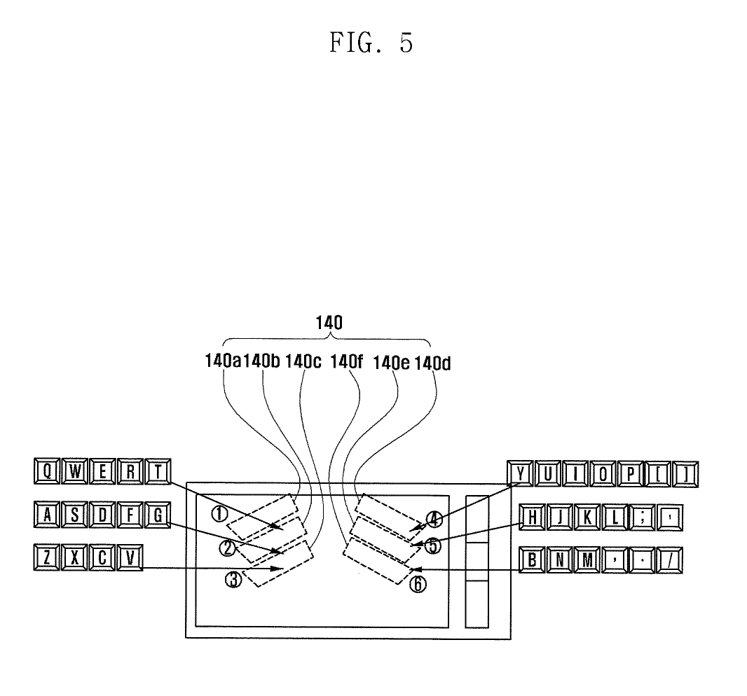

In particular, the controller 110 inputs a character corresponding to a displacement of a touch while the touch maintains. That is, the controller 110 extracts a character mapped to a displacement of a touch sensed by the touch input unit 140 from the memory 120 and inputs a corresponding character. A detailed operation of the controller 110 will be explained with reference to FIG. 4A to FIG. 10B below.

The display unit 130 may be configured with a Liquid Crystal Display (LCD), an Organic Light Emitting Diode (OLED), or an Active Matrix Organic Light Emitting Diode (AMOLED). The display unit 130 visibly provides a menu of the apparatus 100 for inputting a character, input data, function setting information, and various other information to a user. The display unit 130 outputs a booting screen, an idle screen, a menu screen, a call screen, and other application screens of the apparatus 100 for inputting a character.

The display unit 130 according to an embodiment of the present invention displays characters input from the controller 110. When a character is input from a character message creation interface, the input character may be displayed at a cursor location. When vowels are combined with consonants to achieve one combining character like Hangeul, respective consonants-vowels constituting the combining character may be input. The input consonants-vowels may constitute the combining character and the display unit 130 may display the combining character.

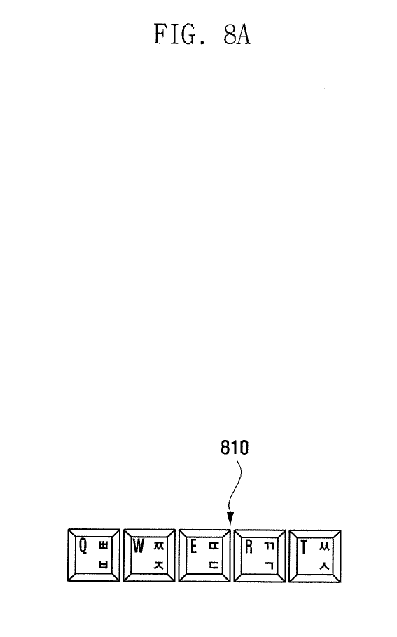

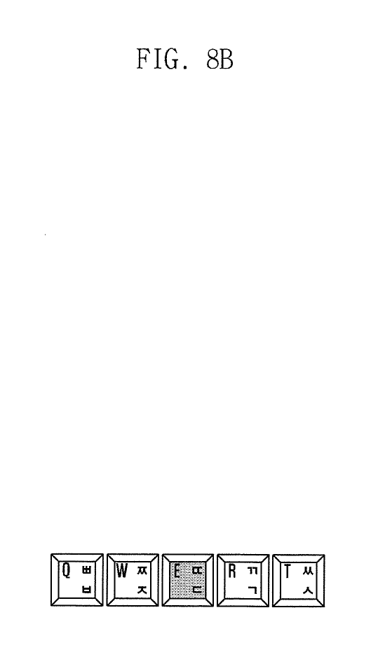

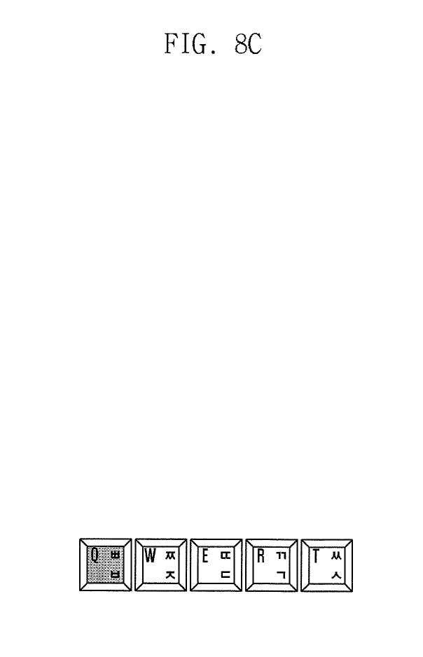

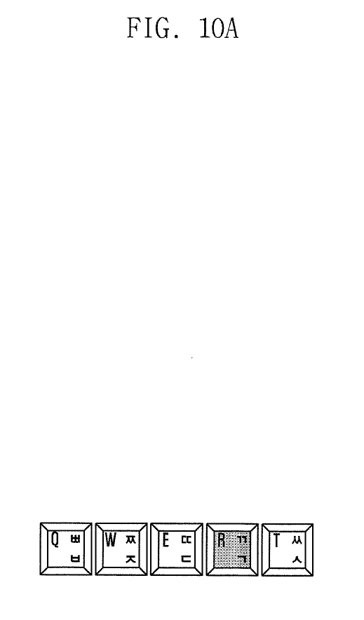

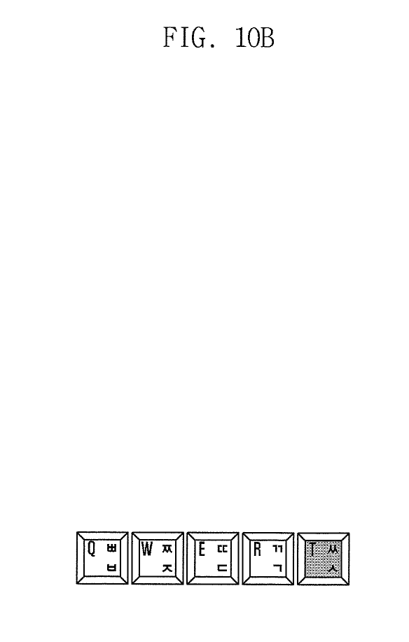

The display unit 130 may further display an interface for supporting character input by a user. For example, when a touch is generated on the touch input unit 140, the display unit 130 may display corresponding characters on the touch input unit 140. Further, when a contact point of a touch moves while the touch maintains, the display unit 130 may display a character corresponding to a displacement of the touch distinguished from another displayed character. The interface for supporting character input by a user will be described with reference to FIG. 5, FIG. 8A. to FIG. 8C, and FIG. 10A to FIG. 10B below.

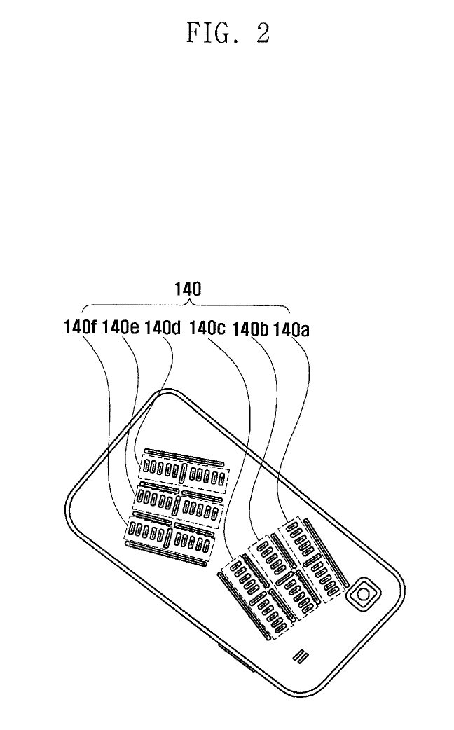

FIG. 2 is a rear view illustrating an apparatus for inputting a character according to an embodiment of the present invention.

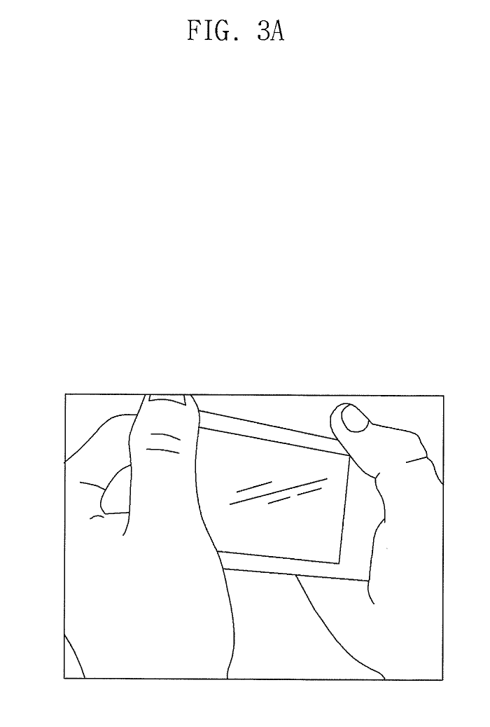

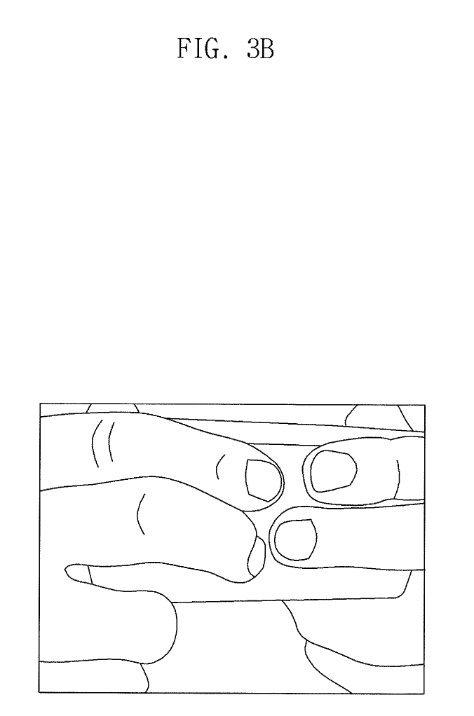

FIG. 3A and FIG. 3B are views illustrating examples of an apparatus for inputting a character according to an embodiment of the present invention.

Referring to FIG. 2, six touch input units 140 are provided at a rear surface of the apparatus 100. Here, the rear surface means an opposite surface of the display unit 130. When the touch input unit 140 is disposed at a rear surface of the apparatus 100 as shown in FIG. 2, a user may touch the touch input unit 140 with fingers (e.g., ring fingers and long fingers) on the rear surface while viewing a display unit 130 on a front surface, as shown in FIGS. 3A and 3B.

For example, the touch input unit 140 may be provided at a surface of a battery cover on a rear surface of the apparatus 100. The battery cover covers a battery unit supplying power to the apparatus 100. When the apparatus 100 does not include the battery cover, the touch input unit 140 may be disposed at a rear surface of the apparatus 100 to be attached to a battery. When the touch input unit 140 is disposed at a surface of the battery cover, the battery cover is not separated from remaining parts of the apparatus 100 but maintains the connection by a Flexible Printed Circuit Board (FPCB) upon exchanging the battery. The touch input unit 140 and the controller 110 may connect with each other through the FPCB to exchange data. When a substrate is folded or rolled, a conductor connection enables the FPCB to transmit signals. In an embodiment of the present invention, a copper line or a general substrate may be used to connect the battery with remaining parts of the apparatus 100.

FIG. 4A is a flowchart illustrating a method for inputting a character according to a first embodiment of the present invention.

A controller 110 determines whether a character input mode is selected (block 410). For example, when a message edit interface or a menu input interface is activated, the character input mode may be selected. In some situations, a user, a hardware producer, or a software developer may set whether to select the character input mode. When the character input mode is not selected, the process returns to block 410 and the control unit 110 waits for selection of the character input mode. Alternatively, when the character input mode is selected, the control unit 110 proceeds to the next block, i.e. block 420, to input a character using touch input. When a set function is executed in a state where input through the touch input unit 140 is not activated in ordinary times, the input through the touch input unit 140 is activated. The input through the touch input unit 140 may be activated in all situations according to an embodiment.

The controller 110 determines whether one of the touch input units 140 senses generation of a touch (block 420). When one of the touch input units 140 senses the generation of a touch, the process goes to block 422. Alternatively, when no touch input units 140 sense the generation of a touch, the controller 110 waits until the generation of a touch is sensed (block 421). Sensing a generation of a touch is a known technology and thus the detailed description thereof is appropriately omitted.

The touch input unit 140 stores a first generated point of the touch (block 422). The first generated point of the touch is used to calculate a displacement of the touch later.

The touch input unit 140, having sensed the generation of the touch, monitors a current location of a contact point of the touch (block 430).

The touch input unit 140 calculates a displacement of a touch using a difference between the current touch contact point and the first generated point of the touch (block 431). The displacement of the touch means the difference between the current touch contact point and the firstly generated point of the touch. The touch input unit 140 may sense the displacement of the touch through block 422, block 430, and block 431.

The controller 110 determines whether the touch sensed at block 420 is terminated (block 440). When the touch continuously maintains, the process returns to block 430 and the touch input unit 140 repeatedly monitors a current location of a contact point of the touch. Alternatively, when the touch is terminated, the process goes to block 450.

The controller 110 extracts a character corresponding to the displacement of the touch when the touch is terminated (block 450). Referring to FIG. 1, the memory 120 maps a corresponding character to the displacement of the touch and stores the mapped result. The controller 110 receives the displacement of the touch from the touch input unit 140 and extracts a character corresponding to the received displacement of the touch from the memory 120.

As shown in FIG. 2, it is assumed that the touch input unit 140 is disposed in the apparatus 100.

Characters may be mapped to a first touch part 140a through a sixth touch input part 140f, for example, as listed in the following Table 1.

TABLE 1

| Touch input unit | Displacement | Character |
|---|---|---|
| First touch input part 140a | −3 | Q |
| First touch input part 140a | −2 | W |
| First touch input part 140a | −1 | E |
| First touch input part 140a | 1 | R |
| First touch input part 140a | 2 | T |
| Second touch input part 140b | −3 | A |
| Second touch input part 140b | −2 | S |
| Second touch input part 140b | −1 | D |
| Second touch input part 140b | 1 | F |
| Second touch input part 140b | 2 | G |
| Third touch input part 140c | −2 | Z |
| Third touch input part 140c | −1 | X |
| Third touch input part 140c | 1 | C |
| Third touch input part 140c | 2 | V |
| Fourth touch input part 140d | — | — |
| Fifth touch input part 140e | — | — |
| Sixth touch input part 140f | — | — |

For convenience of description, the mapping relationship of fourth to sixth touch input parts 140d, 140e, 140f is omitted. A person of skill in the art will understand that additional or other characters may be mapped to touch input parts 140d, 140e, 140f.

The mapping relationship of Table 1 maps a displacement of a touch to a QWERTY keyboard.

In an example of the apparatus 100 shown in FIG. 2, it is assumed that a displacement has a negative value in a left direction of a user and has a positive value in a right direction of the user, or vice versa. Alternatively, upward and downward directions may be as a reference axis to measure a displacement of a touch. In another alternative, a combination of the left and right directions and the upward and downward directions may be used as a reference axis to measure the displacement of a touch. A direction deviated from a left or right direction may be used as a reference axis to measure the displacement of a touch.

The size of the displacement in Table 1 may be measured using a constant unit length as a reference. For example, when a contact point of a touch moves by 2 mm, the controller 110 may determine that the contact point of the touch moves by 1 unit. In the same manner, when a contact point of a touch moves by 4 mm, the controller 110 may determine that the contact point of the touch moves by 2 units. A suitable value may be selected as the unit length suited to an input operation of a user.

For example, after touching the first touch input part 140a, if the user moves a finger in a left direction of the user by 2 mm while maintaining the touch, and releases the finger from the first touch input part 140a, a displacement of the touch becomes −1 unit. In this situation, a character ‘E’ corresponding to a combination of the first touch input part 140a and the displacement of −1 unit may be input.

The foregoing embodiments have been described with no characters corresponding to a displacement of 0 units in Table 1. However, when the displacement the touch is 0 units according to an embodiment (e.g., when a user removes a finger at a touch location without moving a contact point), a corresponding character may be input.

Although Table 1 provides one embodiment, other mapping relationships may be achieved by setting of a user, a hardware producer, or a software provider. A combination of each touch input unit 140 and the displacement and a relationship mapping of characters to the displacement of the touch may change according to a separate key input or operation. For example, if a user inputs a Korean/English conversion key or performs a corresponding function, a Hangeul (Korean) two-component system keyboard instead of QWERTY may correspond to a combination of the touch input unit 140 and the displacement.

The controller 110 inputs characters extracted at block 450 (block 460). When the extracted characters are input, the apparatus 100 may perform an operation corresponding to the input characters. For example, if a user is editing contents of a character message to transmit a character message, a character input at a current cursor location is displayed and the input character is applicable in the contents of a character message. For example, when the user is selecting a menu (e.g., when a menu selection interface is activated), a menu corresponding to an input character may be selected.

Here, although it is assumed that there are a plurality of touch input units 140, the apparatus 100 may include only one touch input unit 140. In this situation, the touch input unit 140 should be designed to have a significantly large size and input many characters according to a combination of moving distances of vertical and horizontal directions and moving directions.

An embodiment of FIG. 4A is used when an interface that provides information on selected characters is unnecessary for a user that is sufficiently skilled in the touch input unit 140. However, a beginner may want or need information associated with selected characters. This is described with reference to FIG. 4B. An embodiment of FIG. 4A and an embodiment of FIG. 4B are selectively applicable according to user setting. The apparatus 100 may provide an interface setting to indicate which of a method of FIG. 4A or a method of FIG. 4B a user will use.

FIG. 4B is a flowchart illustrating a method for inputting a character according to a second embodiment of the present invention.

Since blocks 410, 420, 421, 422, 430, 431, 440, 450, and 460 of FIG. 4B are identical with blocks 410, 420, 421, 422, 430, 431, 440, 450, and 460 of FIG. 4A, they will be simply described.

FIG. 4B is an embodiment providing an interface for providing help when a user is not skilled in the use of the apparatus 100 for inputting a character.

A controller 110 determines whether a character input mode is selected (block 410). For example, when a message edit interface or a menu input interface is activated, the character input mode may be selected. When the character input mode is not selected, the process returns to block 410 and the control unit 110 waits for selection of the character input mode. Alternatively, when the character input mode is selected, the controller 110 displays a character corresponding to the touch input unit 140 (block 415).

The controller 110 controls, at block 415, a display unit 130 to display a character corresponding to the touch input unit 140 in which a touch is generated.

As illustrated referring to Table 1, if the apparatus 100 includes a plurality of touch input units 140, characters corresponding to respective touch input units 410 may be differently allotted. However, in another embodiment, some characters may be allotted corresponding to a plurality of touch input units 140.

FIG. 5 is a view illustrating an example of a screen displayed on a display unit 130 according to a second embodiment of the present invention.

When a character input mode is selected, the display unit 130 may display respective characters corresponding to touch input parts 140a-140f at corresponding locations, as shown in FIG. 5. That is, the display unit 130 may display a character capable of inputting through a corresponding touch input unit 140 at a location in which a touch input unit 140 disposed at a rear surface is projected. In this situation, characters corresponding to respective touch input units 140 may be arranged in an order of the displacement. In practice, a character selected by sliding the touch input unit 140 in a left direction is displayed on the left side and a character selected by sliding the touch input unit 140 in a right direction is displayed on the right side. For example, Q (−3 units), W (−2 units), E (−1 unit), R (1 unit), and T (2 units) corresponding to a first touch input part 140a may be sequentially displayed on a left side. For example, when characters are arranged in an order like a QWERTY keyboard arrangement order, a user may easily input the characters. A user may perform slide input using an interface of FIG. 5 to select a character along a visible direction.

Referring back to FIG. 4B, the controller 110 determines whether one of touch input units 140 senses generation of a touch (block 420). When the one of touch input units 140 senses the generation of a touch, the process goes to block 422. Alternatively, when no touch input unit 140 senses the generation of a touch, the controller 110 waits until the generation of a touch is sensed (block 421). Sensing generation of a touch is a known technology and thus the detailed description thereof is appropriately omitted.

The touch input unit 140 stores a first generated point of the touch (block 422). The first generated point of the touch is used to calculate a displacement of the touch later.

The controller 110 controls the display unit 130 to display characters corresponding to a touch input unit 140 in which generation of a touch is sensed and distinguished from other characters. The display unit 130 may display a character of a touch input unit 140 in which a touch is sensed and distinguished from characters of other touch input units 140 such that a user may recognize the touch input unit 140 in which a touch is sensed. For example, the display unit 130 may display the touch input unit 140 in which a touch is sensed with a different color or use a corresponding character surrounded by a box. A pattern displaying a background color of a corresponding character with a different color may also be used. For example, when a touch is sensed on the first touch input part 140a, background colors of ‘Q, W, E, R, T’ characters corresponding to the first touch input part 140a may be displayed with a yellow color, and background colors of characters corresponding to other touch input parts 140b-140f may be displayed with a white color.

In another embodiment, when characters corresponding to respective touch input units 140 are not displayed at block 415, and then generation of a touch is sensed at one of the touch input units 140 at block 420, only a character corresponding to the touch input unit 140 may be displayed (block 425). For example, if a touch is sensed on the first touch input part 140a, the display unit 130 may display characters, namely ‘Q, W, E, R, T’ corresponding to the first touch input part 140a at a location corresponding to the first touch input part 140a but not display other characters. If a touch is sensed on the second touch input part 140b, the display unit 130 may display characters, namely ‘A, S, D, F, G’ corresponding to the second touch input part 140b at a location corresponding to the second touch input part 140b but not display other characters. In a modified embodiment, the display unit 130 may display a character corresponding to a touch input unit in which a touch is sensed at the same set location regardless which touch input part 140 has detected a touch.

The touch input unit 140, having sensed the generation of the touch, monitors a current location of a contact point of the touch (block 430).

The touch input unit 140 calculates a displacement of a touch using a difference between the current touch contact point and the first generated point of the touch (block 431). In this situation, the displacement of the touch means the difference between the current touch contact point and the first generated point of the touch. The touch input unit 140 may sense the displacement of the touch through block 422, block 430, and block 431.

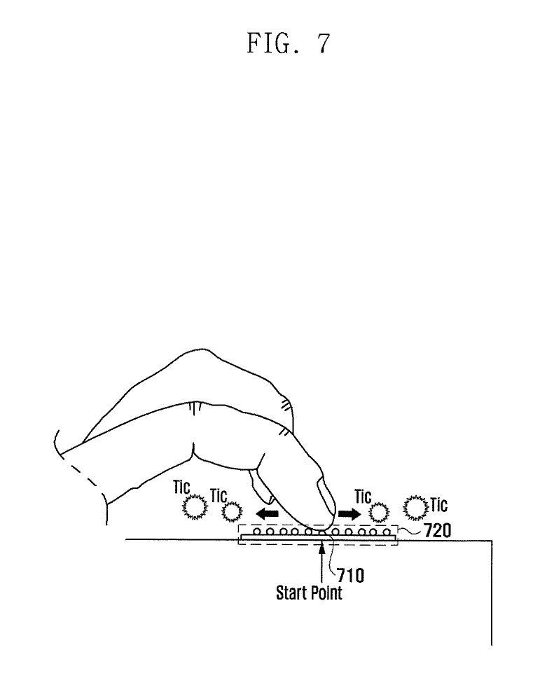

The controller 100 controls the display unit 130 to display a character corresponding to a displacement of a touch sensed by the touch input unit 140 and a combination of a corresponding touch input unit distinguished from other characters (block 435). To separately display the character, a manner such as change in a background color or an underline display may be used. Separate display of a character at block 435 will be described with reference to FIG. 7 through FIG. 10B in detail below.

The controller 110 determines whether the touch sensed at block 420 is terminated (block 440). When the touch is terminated, the controller 110 goes to block 450 to perform character input. Alternatively, when the touch continuously maintains, the process returns to block 430, and the controller 110 repeats a displacement sensing procedure of blocks 430 and 431 and a procedure of block 434 separately displaying a character corresponding to a displacement of the touch until the touch is terminated.

The controller 110 extracts a character corresponding to the displacement of the touch when the touch is terminated (block 450). The controller 110 inputs extracted characters (block 460) and the display unit 130 displays the input characters (block 465). As illustrated with reference to FIG. 4A, the input characters are not necessarily continuously displayed. It will be sufficient that the controller 110 performs an operation according to the character input.

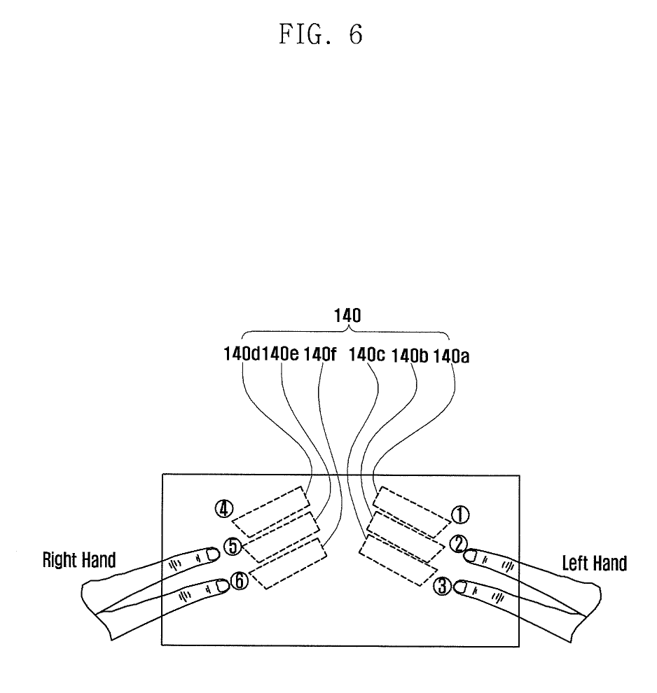

FIG. 6 is a schematic diagram illustrating a touch input type according to a second embodiment of the present invention. FIG. 6 is a screen of an apparatus for inputting a character viewed from a rear side. A left ring finger of a user may touch the first touch input part 140a and the second touch input part 140b, and a left long finger of the user may touch a third touch input part 140c. In the same manner, a right ring finger of the user may touch a fourth touch input part 140d and a fifth touch input part 140e, and the left long finger of the user may touch a sixth touch input part 140f. An interface of FIG. 5 may be displayed corresponding to a disposition of the touch input unit 140 in FIG. 6.

FIG. 7 to FIG. 10B are views illustrating a character selection scheme according to a touch.

Referring to FIG. 7, projection portions 720 are formed on the touch input unit 140 at predetermined intervals. A center projection portion 710 located at a center of the touch input unit 140 may have a shape and a size different from those of the projection portions 720. That is because a user may recognize a center location with sensitivity of a finger. For example, the projection portions 720 may be formed at intervals of 2 mm. However, a distance between the center projection portion 710 and a projection portion 720 right next thereto may be greater than the distance between adjacent projection portions 720. That also is because a user may recognize a center location with sensitivity of a finger. The projection portions 720 represent one example of a structural element of the present invention. Other elements that provide a user a manner to detect how long a touch contact has been moved from a start point without seeing the touch input (e.g., through the sense of touch or hearing) may be substituted for the projection portions 720.

For example, when the touch contact point moves by a set distance, a scheme generating a vibration (namely, Haptic) may be used instead of the projection portions 720.

In an embodiment, an interval between the projection portions 720 corresponds to a unit length of a displacement of touch input illustrated in Table 1. However, in other embodiments, two times (or another multiple of) an interval between the projection portions 720 may correspond to the unit length of a displacement of touch input. Here, it is assumed that the interval between the projection portions 720 corresponds to a unit length of a displacement of touch input illustrated in Table 1. The interval between the projection portions 720 is displayed in the ‘Displacement’ column of Table 1.

For example, if a user moves a contact point of a finger from a start point to a projection portion right next thereto in a state that the finger contacts with the touch input unit 140, that is, when the user performs slide input, the user may recognize that the finger moves by a displacement of 1 unit.

FIG. 8A to FIG. 8C illustrate a procedure for selecting a character by slide input.

FIG. 8A to FIG. 8C illustrate an embodiment where a touch is input on the first touch input part 140a of Table 1.

FIG. 8A illustrates a selection state directly after generation of a touch input. A cursor 810 is located between ‘E’ and ‘R’ and no characters are selected yet. Next, when the user moves a contact point in a left direction by one column, namely to a projection portion at a right left side of a start point 710 while maintaining a contact with the first touch input part 140a, a character ‘E’ is selected as shown in FIG. 8E. Subsequently, when the user moves a contact point in a left direction by two more columns, namely to a third left projection portion from a start point 710 while maintaining a contact with the first touch input part 140a, a character ‘Q’ is selected as shown in FIG. 8C.

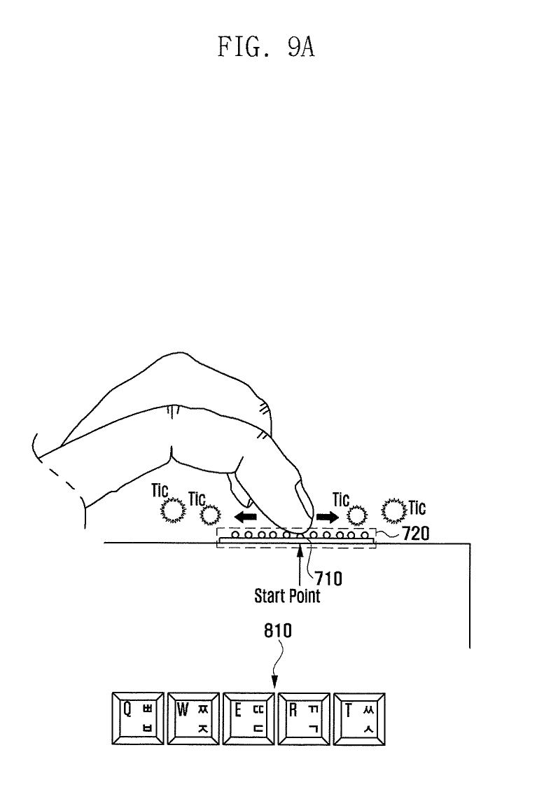

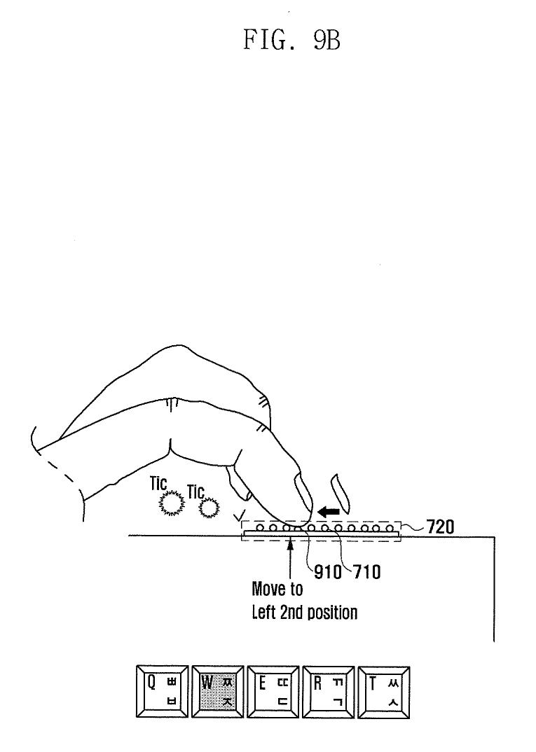

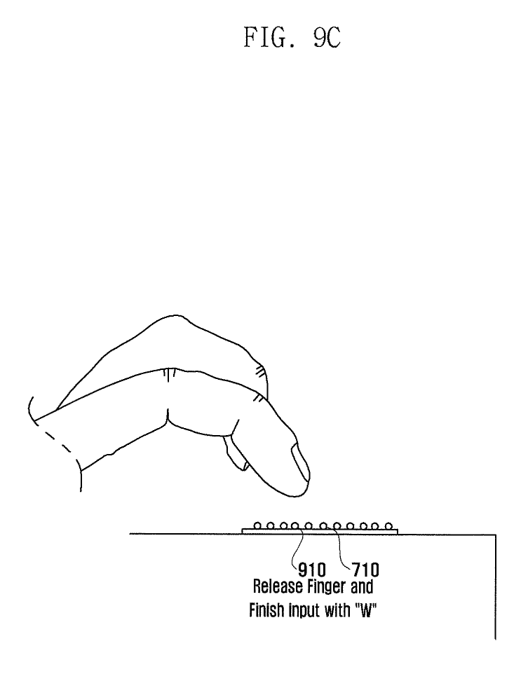

A procedure for inputting a character will be described with reference to FIG. 9A to FIG. 9C in detail.

Referring to FIG. 9A, a user generates a touch at a start point. A cursor is located between ‘E’ and ‘R’ directly after the touch is sensed. Next, the user moves a contact point to a second left position 910 as shown in FIG. 9B while maintaining the contact. Accordingly, a character ‘W’ is selected. After moving the contact point to a left second position, when the user terminates a contact between a first touch input part 140a and a finger, a finally selected character ‘W’ is input.

Referring to FIG. 10A and FIG. 10B, the apparatus 100 may equally process a displacement of an opposite direction.

For example, after generating a touch on the first touch input part 140a, when the user moves a contact point to a left projection portion of a start point while maintaining the touch, a character ‘R’ may be selected. If the user moves the contact point to a right projection portion by one more column, a character ‘T’ is selected. In the same manner, when the touch is terminated, a finally selected character is input.

Embodiments of FIG. 7 to FIG. 10B have illustrated projection portions 720 formed on the touch input unit 140. However, substantially the same explanations are applicable to formation of a depression portion in place of the projection portions 720. Further, embodiments of FIG. 7 to FIG. 10B have illustrated a method where a character selected at the time of terminating the touch input is input. The same explanations are applicable to a method where a character selected at the input time of a separate button is input. The same explanations are applicable to a method where a character selected at the input time of a touch screen or a separate touch input is input.

The display unit 130 may display a currently selected character in a manner illustrated in FIG. 8A to FIG. 8C or FIG. 10A and FIG. 10C distinguished from other characters. Here, a manner changing a background color of a selected character is selected. In another embodiment, the selected character may be displayed distinguished from other characters in such a way that a color or a font of a selected character changes, the selected character is underlined, or the selected character is surrounded by a box.

It is assumed that a touch of a user starts from a center projection portion 710 as described with respect to FIG. 7 to FIG. 10B. However, it is unnecessary to start the touch of a user from the center projection portion 710. The controller 110 inputs a character corresponding to a touch displacement regardless of the center projection portion 710. That is, because a difference between a start point of the touch and a termination point of the touch is a touch displacement, although the touch starts from a certain point, when the touch is terminated after a contact point moves from the start point to a left side by one column, a character ‘E’ may be selected.

The display unit 130 displays the input character (block 435).

Here, it will be appreciated that combinations of process flowcharts and respective blocks thereof may be achieved by instructions of a computer program. Because instructions of a computer program may be mounted in a processor of a general-purpose computer, a special computer, or a programmable data processing equipment, they generate means for executing functions described in flowchart block(s). Because the instructions of a computer program may be stored in a computer usable or readable memory of a computer or a programmable data processing equipment to implement a function in a specific way, they may produce manufacturing goods including instruction means executing functions described in flowchart block(s). Because the instructions of a computer program may be mounted in a computer or a programmable data processing equipment, a series of operation stages are executed on the computer or the programmable data processing equipment to produce a process executed by the computer such that the instructions executing the computer or the programmable data processing equipment may provide stages for executing functions described in flowchart block(s).

Further, each block may indicate a part of a module including at least one executable instruction for executing specific logical function(s), a segment, and a code. In substitute execution embodiments, it should be noticed that functions mentioned in blocks may be created in any order. Two sequentially shown blocks may be performed sequentially, simultaneously, or be performed in a reverse order according to a corresponding function.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. An apparatus for inputting a character, the apparatus comprising:
a touch input unit configured to sense a generation and a contact point of a touch;
a memory configured to store mapping information regarding a displacement and a character according to movement of the generated touch;
a controller configured to extract and output a character corresponding to a displacement of a sensed touch while the touch maintains upon sensing the touch; and
a display unit configured to display the output character.

2. The apparatus of claim 1, wherein the touch input unit is located on a surface opposite to the display unit.

3. The apparatus of claim 1, wherein the touch input unit comprises a plurality of projection portions or repression portions provided at a surface of the touch input unit at a set interval.

4. The apparatus of claim 1, wherein the touch input unit comprises a plurality of touch input parts, and characters corresponding to the plurality of touch input parts differ from each other.

5. The apparatus of claim 2, wherein the touch input unit comprises a plurality of touch input parts, and characters corresponding to the plurality of touch input parts differ from each other, and
the controller controls the display unit to display characters corresponding to a touch input unit in which the touch is sensed by referring the memory.

6. The apparatus of claim 5, wherein the controller controls the display unit to display a character corresponding to a displacement of the sensed touch while a touch maintains on the touch input unit distinguished from the other display characters.

7. The apparatus of claim 1, wherein the controller inputs a character corresponding to a displacement of the sensed touch when the sensed touch is terminated.

8. A method for inputting a character in an apparatus with a plurality of touch input units, the method comprising:
sensing a generation and a contact point of a touch by a touch input unit;
extracting and outputting a character corresponding to a displacement of a sensed touch while the touch maintains upon sensing the touch; and
displaying the output character.

9. The method of claim 8, wherein characters corresponding to the plurality of touch input parts differ from each other.

10. The method of claim 9, wherein outputting a character comprises displaying characters corresponding to a touch input unit in which the touch is sensed.

11. The method of claim 10, wherein outputting a character comprises displaying a character corresponding to a displacement of the sensed touch while a touch maintains on the touch input unit distinguished from the other display characters.

12. The method of claim 8, wherein outputting a character comprises outputting a character corresponding to a displacement of the sensed touch when the sensed touch is terminated.

13. The method of claim 8, wherein the output character is displayed at a display unit, the display unit located on a surface opposite to the touch input unit.

14. A portable terminal, comprising:
an apparatus configured to receive an input of a character from a user, the apparatus comprising:
a touch input unit configured to sense a generation and a contact point of a touch;
a memory configured to store mapping information regarding a displacement and a character according to movement of the generated touch;
a controller configured to extract and output a character corresponding to a displacement of a sensed touch while the touch maintains upon sensing the touch; and
a display unit configured to display the output character.

15. The portable terminal of claim 14, wherein the touch input unit is located on a surface of the portable terminal opposite to the display unit.

16. The portable terminal of claim 14, wherein the touch input unit comprises a plurality of projection portions or repression portions provided at a surface of the touch input unit at a set interval.

17. The portable terminal of claim 14, wherein the touch input unit comprises a plurality of touch input parts, and characters corresponding to the plurality of touch input parts differ from each other.

18. The portable terminal of claim 15, wherein the touch input unit comprises a plurality of touch input parts, and characters corresponding to the plurality of touch input parts differ from each other, and
the controller controls the display unit to display characters corresponding to a touch input unit in which the touch is sensed by referring the memory.

19. The portable terminal of claim 18, wherein the controller controls the display unit to display a character corresponding to a displacement of the sensed touch while a touch maintains on the touch input unit distinguished from the other display characters.

20. The portable terminal of claim 14, wherein the controller inputs a character corresponding to a displacement of the sensed touch when the sensed touch is terminated.
